(19) United States
(12) Patent Application Publication
(10) Pub. No.: US 2022/0116513 A1
(43) Pub. Date: Apr. 14, 2022

(54) PRIVACY-PRESERVING RECONSTRUCTION FOR COMPRESSED SENSING

(71) Applicant: Intel Corporation, Santa Clara, CA (US)

(72) Inventors: Raizy Kellermann, Jerusalem (IL); Omer Ben-Shalom, Rishon Le-Tzion (IL); Alex Nayshtut, Gan Yavne (IL)

(73) Assignee: Intel Corporation, Santa Clara, CA (US)

(21) Appl. No.: 17/560,861

(22) Filed: Dec. 23, 2021

(51) Int. Cl. H04N 1/44; G06T 5/00

(52) U.S. Cl. CPC H04N 1/4493; G06T 5/001; G06T 2207/20081; G06T 2207/30201; G06T 2207/20084

(57) ABSTRACT

Privacy-preserving reconstruction for compressed sensing is described. An example of a method includes capturing raw image data for a scene with a compressed sensing image sensor; performing reconstruction of the raw image data, including performing an enhancement reconstruction of the raw image data; and generating a masked image from the reconstruction of the raw image data, wherein the enhancement reconstruction includes applying enhancement utilizing a neural network trained with examples including image data in which private content is masked.

### FIELD

This disclosure relates generally to the field of electronic devices and, more particularly, to privacy-preserving reconstruction for compressed sensing.

### BACKGROUND

Compressed sensing in general refers to an approach to signal processing that allows for signals and images to be reconstructed with lower sampling rates than would normally be required.

Compressed sensing may be utilized in cameras for various purposes, including surveillance operations. One of the key advantages of compressed sensing cameras is their ability to capture a signal in a secure format so that the raw signal is meaningless without a reconstruction phase to generate an image.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 illustrates a compressed sensing apparatus or system, according to some embodiments;

FIG. 2 illustrates processing for a general camera providing private features masking;

FIG. 3A illustrates a processing pipeline of a compressed sensing camera;

FIG. 3B illustrates image reconstruction in a processing pipeline of a compressed sensing camera;

FIG. 4A illustrates a processing pipeline of a privacy preserving compressed sensing camera, according to some embodiments;

FIG. 4B illustrates image reconstruction in a processing pipeline of a privacy preserving compressed sensing camera, according to some embodiments;

FIG. 5 is flowchart to illustrate a process privacy-preserving reconstruction for compressed sensing, according to some embodiments;

FIG. 6A is an illustration of a neural network that may be processed according to some embodiments;

FIGS. 6B and 6C illustrate an example of a neural network that may be processed according to some embodiments; and

FIG. 7 illustrates an embodiment of an exemplary computing architecture for privacy-preserving reconstruction for compressed sensing, according to some embodiments.

### DETAILED DESCRIPTION

Embodiments described herein are directed to privacy-preserving reconstruction for compressed sensing.

There has been a great increase in use of inexpensive compressed-sensing cameras for various purposes, including security, surveillance, and drone video capture. Such compressed-sensing devices can operate with a low number of light sensors that rely on reconstruction algorithms for image composition. The compressed sensing allows for signals and images to be reconstructed with lower sampling rates than would normally be required, and specifically less than required under Nyquist's Law. Nyquist's Law states that a signal is required to be sampled at least twice its highest analog frequency in order to extract all of the information.

Compressed sensing cameras have the ability to capture a signal in a secure format so that the raw signal is meaningless without a reconstruction phase to generate a captured image. A compressed sensing camera does not require a lens, and thus the raw image data is generally not recognizable, However, compressed-sensing cameras, such as surveillance devices or drones' cameras, may with image reconstruction produce images that contain privacy-sensitive content (also referred to here as private content or similar terms).

Existing solutions commonly utilize AI (Artificial Intelligence)-based image recognition models to identify the privacy-sensitive content within captured images, and mask out this content. While the making of private content may be very effective, the processing pipeline in a device or system will still contain the privacy-sensitive data at early stages in process. For this reason, an adversary seeking to subvert the operation of a compressed-sensing apparatus may be able to access and expose the unmasked content in an early stage of processing, and thus defeat efforts to ensure that privacy sensitive content is protected.

In some embodiments, an apparatus, system, or process for compressed sensing integrates a privacy-preserving operation as part of reconstruction processing in a processing pipeline. In some embodiments, a reconstruction network is trained over datasets that have the privacy sensitive features already masked out. In this way, an inference model for image reconstruction may be trained to ignore privacy-sensitive content within image while learning to enhance the rest of the data for an image, and thus remove the potential target of attack.

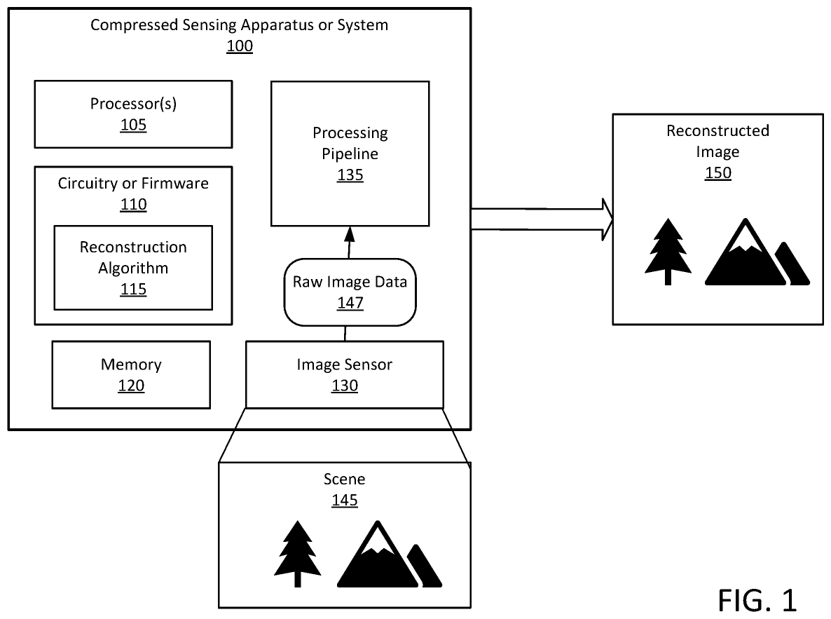

FIG. 1 illustrates a compressed sensing apparatus or system, according to some embodiments. As shown in FIG. 1, a compressed sensing apparatus or system 100, such as a compressed sensing camera, includes an image sensor 130 to capture an image (capturing raw image data), a memory to store data, and a processing pipeline 135 to process the raw image data. The apparatus or system 100 may further include one or more processors 105, and may include circuitry or firmware 110 including a reconstruction algorithm to reconstruct the raw image data to generate a reconstructed image. For example, the image sensor 130 may capture an image of a scene 145 in the form of raw image data 147. The raw image data 147, which may be unrecognizable without reconstruction, is processed through the processing pipeline 135 to generate a reconstructed image 150. The reconstructed image 150 is recognizable image reflecting the contents of the original scene 145.

In some instances, the processing pipeline 135 further includes processing to detect and mask privacy sensitive content such that such content is not visible in the reconstructed image 150. However, an adversary may seek to obtain the privacy sensitive data prior to the masking of the data in the processing pipeline.

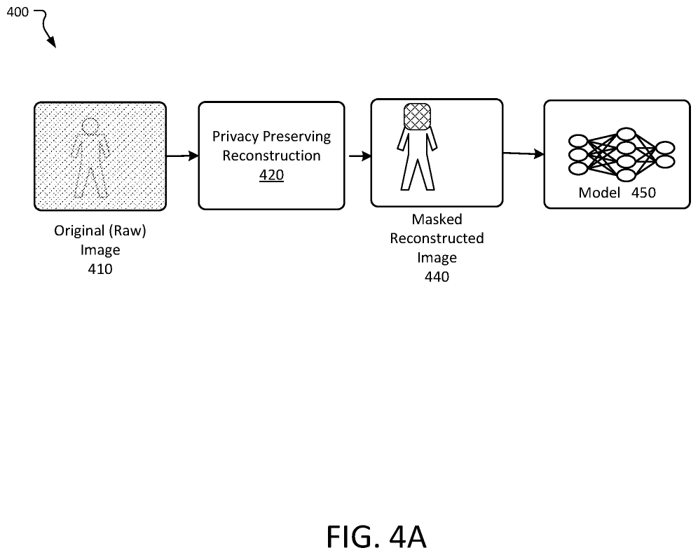

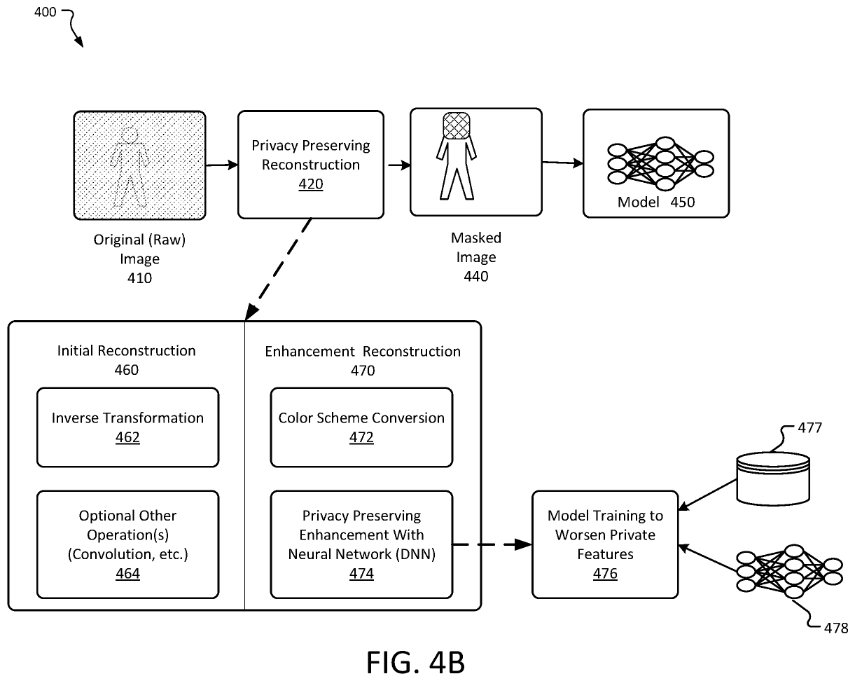

In some embodiments, the apparatus or system includes a privacy-preserving operation as a part of the reconstruction processing in the processing pipeline 135. In some embodiments, a reconstruction network is trained over datasets that have the privacy sensitive features already masked out. The operation of the processing pipeline 135 may be as further illustrated in FIGS. 4A and 4B.

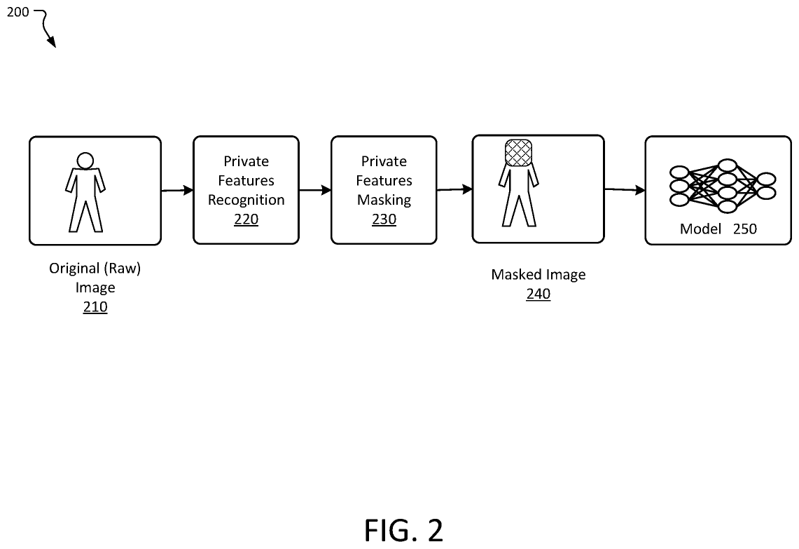

FIG. 2 illustrates processing for a general camera providing private features masking. In FIG. 2, a non-compressed sensing camera or other imaging device (i.e., a general camera or other imaging device) may include a capability to recognize and mask private features in images, thus allowing for the generation of masked images that do not include privacy sensitive features. The processing pipeline for the general camera may include:

(a) Capture of original (raw) image data of a scene 210. As this relates to a general camera, the raw image data may include all captured data from the scene, including privacy sensitive features, in a recognizable form. For example, faces and other identifying or private features of individuals within a captured image will be present.

(b) Private features recognition 220. In private features recognition, the raw image data is processed to identify elements that are expected to contain private content. In an example, an image may be processed to identify faces of persons within the image data.

(c) Private features masking 230. In private features masking, the detected private content is masked so that this content is not visible or assessable in the image data.

(d) Generated masked image 240. The generated masked image 240 will contain the content from the initial raw image with the detected privacy-sensitive content being masked out.

(e) Processing with an inference model 250. If required, the illustrated inference model in FIG. 2 (and other illustrations herein) may reflect an inference operation utilizing machine learning for one or more purposes.

As shown in FIG. 2, with a general camera the raw acquired image data may contain exposed private content. If an attacker is able to obtain the original raw image, the private content may be revealed.

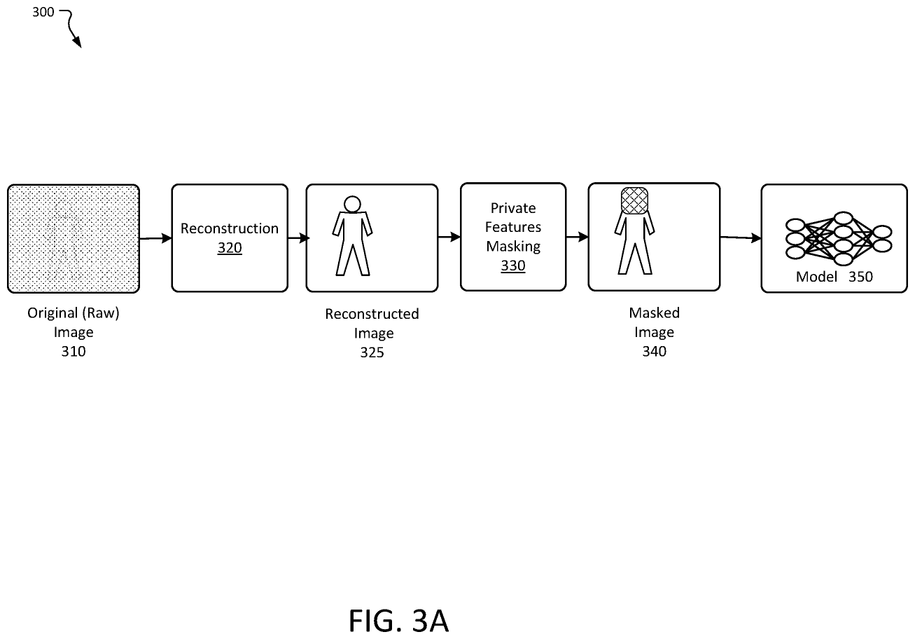

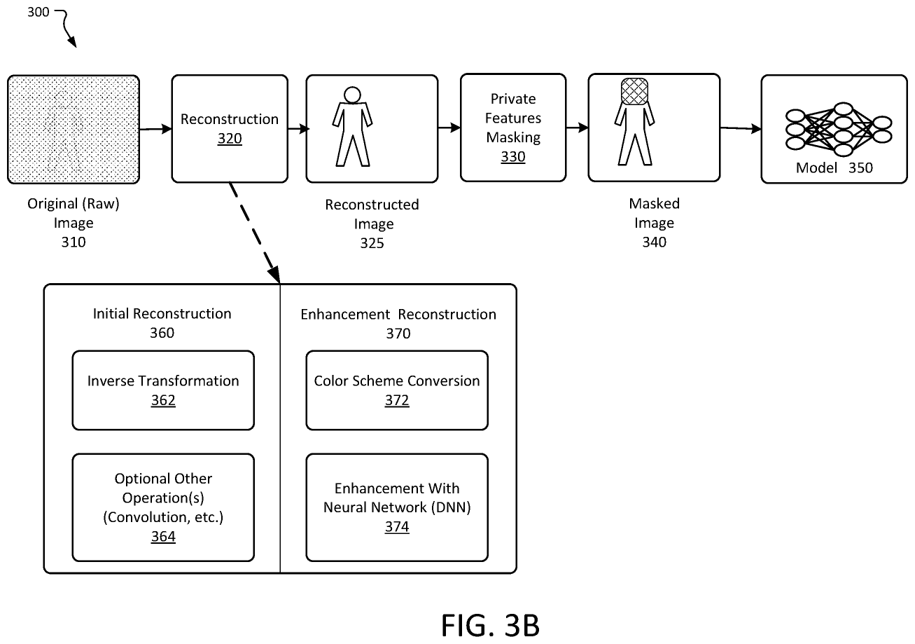

It is noted that FIG. 2, as well as FIGS. 3A-4B, illustrate privacy-sensitive content in terms of the face of an person within a captured image. However, this is only one example provided for simplicity in illustration. Embodiments are not limited to this example, and may include other portions of images that have privacy implications. Other examples may include license plates on motor vehicles, identifiable information connected to dwellings, and other types of information depending on a particular implementation.

FIG. 3A illustrates a processing pipeline of a compressed sensing camera. An existing compressed sensing camera or other imaging device (for example, a FlatCam, a thin, bare sensor camera, and similar cameras) will capture raw image data that is generally meaningless without application of a reconstruction phase to generate an image from the raw date. In particular, the raw image will not provide privacy-sensitive content in a recognizable format.

Operation of the processing pipeline 300 for the compressed sensing camera or other imaging device may include:

(a) Capturing an original raw image 310 of a scene. Private data is not available from the raw image data at this point in the processing pipeline because the data has not yet been reconstructed, and therefore has no meaningful content. (The example raw image data 310 is provided for purposes of illustration, and may not resemble actual captured raw image data.)

(b) Reconstruction process 320, which may be performed according to a reconstruction algorithm.

(c) Reconstructed Image 325. The reconstruction process 320 results in generation of a reconstructed image, wherein the reconstructed image is a full image of the original scene, including any privacy-sensitive content present in the original scene.

(d) Private features recognition and masking 330. In private features recognition, the raw image data is processed to identify elements that re expected to contain private content, and, in private features masking, the detected private features are masked so that these features are not visible or assessable.

(e) Generated masked image 340 following the private features recognition and masking.

(f) Processing with an inference model 350, if required.

As shown in FIG. 3A, in the operation of a compressed-sensing camera the reconstructed image 325 may contain private content because this is prior to the private features masking operation. The processing pipeline 300 thus can still expose the privacy-sensitive content of captured images at early stages of the pipeline, and an adversary may be able to acquire this unmasked content after reconstruction.

FIG. 3B illustrates image reconstruction in a processing pipeline of a compressed sensing camera. The reconstruction process 320 of the pipeline 300 illustrated in FIG. 3A may include:

(i) Initial reconstruction 360 of the original raw image. The initial reconstruction includes inverse transformation 362 and optionally other operations, such as convolution and others 364.

(ii) Enhancement reconstruction 370. The initial reconstruction may further include enhancement, including color scheme conversion 372 and enhancement utilizing a neural network 374, such as a DNN (Deep Neural Network).

As shown, the example compressed sensing camera processing pipeline remains vulnerable to access to private data by an adverse party who has access to the pipeline.

FIG. 4A illustrates a processing pipeline of a privacy preserving compressed sensing camera, according to some embodiments. In some embodiments, a compressed sensing camera or other imaging device, such as the compressed sensing apparatus or system 100 illustrated in FIG. 1, includes a processing pipeline to process image data. In some embodiments, a privacy-preserving operation is implemented as part of reconstruction processing. To implement this, a reconstruction network is trained over datasets having the privacy content already masked out. In this was the model is trained to ignore the privacy-sensitive content while learning to enhance the rest of the signals.

In some embodiments, operation of a processing pipeline 400 for a compressed sensing camera includes:

(a) Capturing an original raw image 410. Private data is not available from the raw image data at this point in processing pipeline because the data has not been reconstructed.

(b) Privacy Preserving Reconstruction process 420, which may be performed according to a reconstruction algorithm. In some embodiments, the privacy preserving reconstruction combines reconstruction of raw with private features recognition and masking.

(c) Masked Reconstructed Image 440. The privacy preserving reconstruction process results in generation of a reconstructed image that includes masking of private content.

(d) Processing with an inference model 450.

In some embodiments, the processing pipeline of the privacy preserving compressed sensing camera does not make unmasked private content available, thus preventing an adverse party from obtaining private data through access of such pipeline.

FIG. 4B illustrates image reconstruction in a processing pipeline of a privacy preserving compressed sensing camera, according to some embodiments. In some embodiments, the privacy preserving reconstruction process 420 of the processing pipeline 400 illustrated in FIG. 4A includes:

(i) Initial reconstruction 460 of the original raw image. The initial reconstruction includes inverse transformation 462 and optionally one or more other operations, such as convolution 464.

(ii) Enhancement reconstruction 470. In some embodiments, initial reconstruction may further include enhancement, including color scheme conversion 472 and privacy preserving enhancement utilizing a neural network 474, such as a DNN (Deep Neural Network). The privacy preserving enhancement includes model training to worsen private features in an image 476, which includes training over datasets (datasets shown in database 477 and training utilizing neural network inference model 478) that have the privacy sensitive features already masked out. In this way, the inference model 478 is trained to ignore the privacy-sensitive details within images while learning to enhance the rest of the signals, and thus removing the potential target of attack.

In some embodiments, the processing pipeline 400 for a compressed sensing camera thus provides a combination of reconstruction processing and privacy preserving processing that may be utilized to prevent attacks that are directed to unprotected private content in a processing pipeline because such content is inaccessible within such processing pipeline.

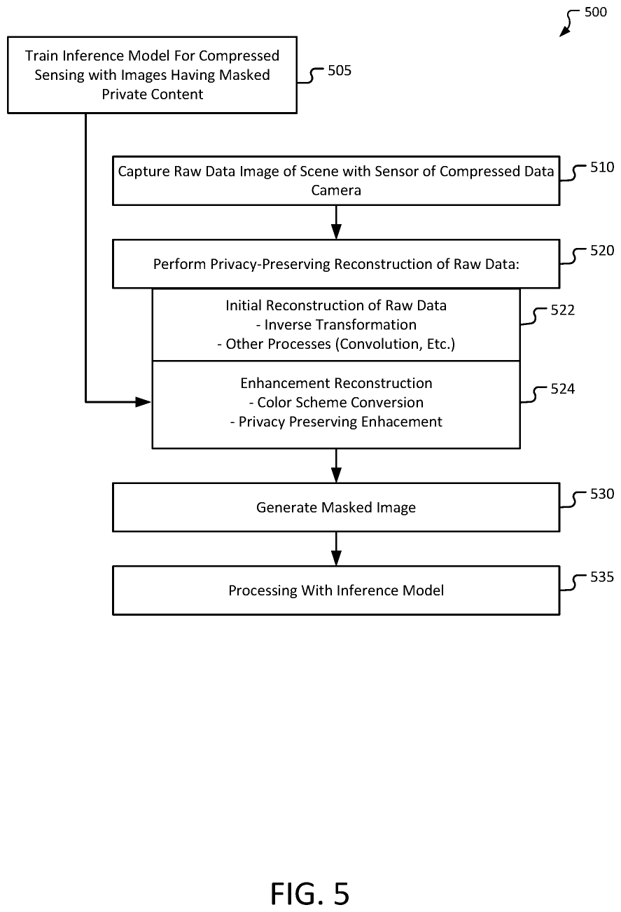

FIG. 5 is flowchart to illustrate a process privacy-preserving reconstruction for compressed sensing, according to some embodiments. In some embodiments, a process 500 for compressed sensing utilizing a compressed sensing camera, such as in a compressed sensing apparatus or system 100 as illustrated in FIG. 1, includes training an inference model for compressed sensing with images having private content is already masked 505. The inference model is thus trained to ignore privacy-sensitive content within images while learning to enhance the rest of the signals in the image.

The process 500 provided for capturing raw image data of an image with the image sensor of the compressed sensing camera 510. Privacy-preserving reconstruction of the raw image data is then performed 520. The reconstruction may include initial reconstruction of the image 522, which may include performing an inverse transformation of the image data and performing one or more other processes, such as convolution, etc. Using the results from the initial reconstruction, the privacy preserving reconstruction 520 further proceeds with enhancement reconstruction 524, the enhancement reconstruction includes color scheme conversion application of privacy preserving enhancement. The privacy preserving enhancement includes application of the inference model that is trained with images having private content already masked 505.

The privacy preserving reconstruction 520 operates to generate a masked image 530, the masked image including masking of private content within the image. The process 500 may then continue with processing with an inference model 535, as required for the operation of the compressed sensing camera.

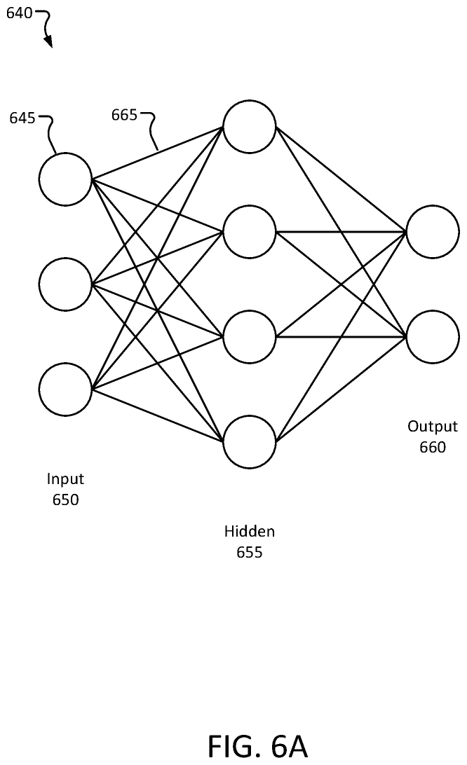

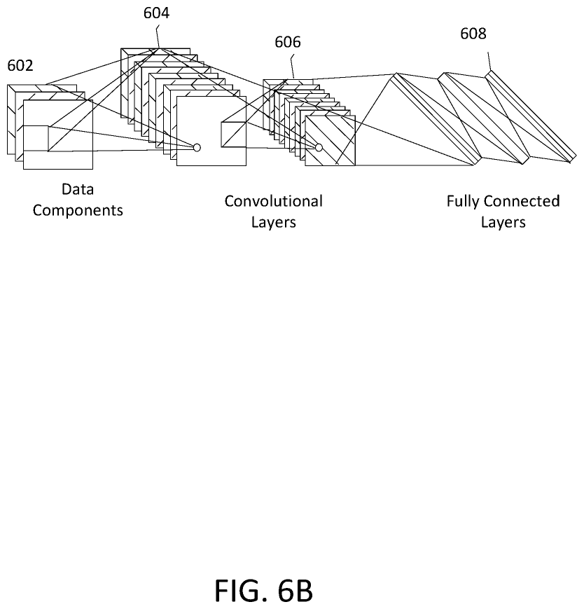

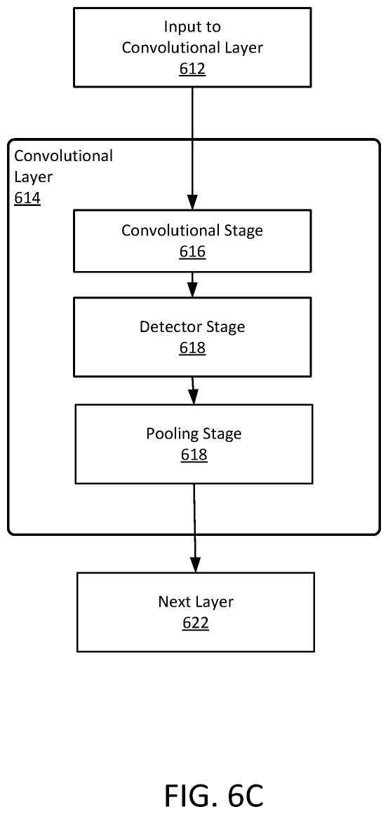

FIG. 6A is an illustration of a neural network that may be processed according to some embodiments. As illustrated in FIG. 6A, a neural network 640, such as neural network in a classifier apparatus or system, includes a collection of connected units or nodes 645, also referred to as artificial neurons. Typically, nodes are arranged in multiple layers. Different layers may perform different transformations on their inputs. In this simplified illustration the neural network includes the nodes in layers that include an input layer 650, one or more hidden layers 655, and an output layer 660. Each connection (or edge) 665 can transmit a signal to other nodes 645. A node 645 that receives a signal may then process it and signal nodes connected to it. The nodes and edges typically have a weight that adjusts as learning proceeds.

Neural networks, including feedforward networks, CNNs (Convolutional Neural Networks, and RNNs (Recurrent Neural Networks) networks, may be used to perform deep learning. Deep learning refers to machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different task.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

FIGS. 6B and 6C illustrate an example of a neural network that may be processed according to some embodiments. FIG. 6B illustrates various layers within a CNN as a specific neural network example. However, embodiments are not limited to a particular type of neural network. As shown in FIG. 6B, an exemplary neural network used to, for example, model image processing can receive input 602 describing, for example, the red, green, and blue (RGB) components of an input image (or any other relevant data for processing). The input 602 can be processed in this example by multiple convolutional layers (e.g., convolutional layer 604 and convolutional layer 606). The output from the multiple convolutional layers may optionally be processed by a set of fully connected layers 608. Neurons in a fully connected layer have full connections to all activations in the previous layer, as previously described for a feedforward network. The output from the fully connected layers 608 can be used to generate an output result from the network. The activations within the fully connected layers 608 can be computed using matrix multiplication instead of convolution. Not all CNN implementations make use of fully connected layers 608. For example, in some implementations the convolutional layer 606 can generate output for the CNN.

FIG. 6C illustrates exemplary computation stages within a convolutional layer of a CNN. Input to a convolutional layer 612 of a CNN can be processed in three stages of a convolutional layer 614. The three stages can include a convolution stage 616, a detector stage 618, and a pooling stage 620. The convolution layer 614 can then output data to a successive convolutional layer 622. The final convolutional layer of the network can generate output feature map data or provide input to a fully connected layer, for example, to generate a classification value for the input to the CNN.

In the convolution stage 616 several convolutions may be performed in parallel to produce a set of linear activations. The convolution stage 616 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 616 defines a set of linear activations that are processed by successive stages of the convolutional layer 614.

The linear activations can be processed by a detector stage 618. In the detector stage 618, each linear activation is processed by a non-linear activation function. The non-linear activation function increases the nonlinear properties of the overall network without affecting the receptive fields of the convolution layer. Several types of non-linear activation functions may be used. One particular type is the rectified linear unit (ReLU), which uses an activation function defined such that the activation is thresholded at zero.

The pooling stage 620 uses a pooling function that replaces the output of the convolutional layer 606 with a summary statistic of the nearby outputs. The pooling function can be used to introduce translation invariance into the neural network, such that small translations to the input do not change the pooled outputs. Invariance to local translation can be useful in scenarios where the presence of a feature in the input data is more important than the precise location of the feature. Various types of pooling functions can be used during the pooling stage 620, including max pooling, average pooling, and 12-norm pooling. Additionally, some CNN implementations do not include a pooling stage. Instead, such implementations substitute and additional convolution stage having an increased stride relative to previous convolution stages.

The output from the convolutional layer 614 can then be processed by the next layer 622. The next layer 622 can be an additional convolutional layer or one of the fully connected layers 608. For example, the first convolutional layer 604 of FIG. 6B can output to the second convolutional layer 606, while the second convolutional layer can output to a first layer of the fully connected layers 608.

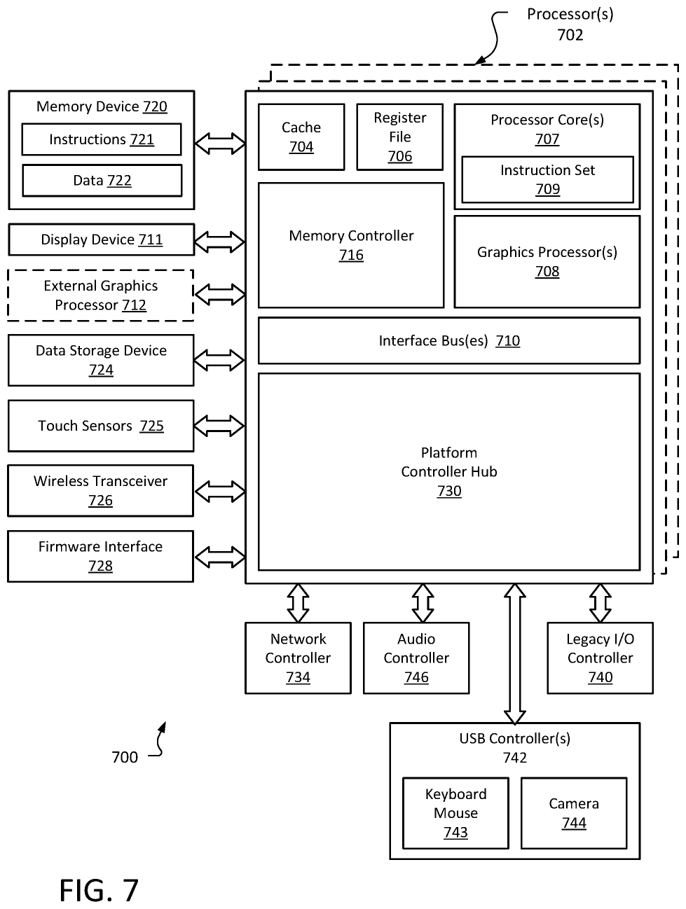

FIG. 7 illustrates an embodiment of an exemplary computing architecture for privacy-preserving reconstruction for compressed sensing, according to some embodiments. In various embodiments as described above, a computing architecture 700 may comprise or be implemented as part of an electronic device. In some embodiments, the computing architecture 700 may be representative, for example, of a computer system that implements one or more components of the operating environments described above. The computing architecture 700 may be utilized to provide privacy-preserving reconstruction for compressed sensing, such as described in FIGS. 1-5.

As used in this application, the terms “system” and “component” and “module” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive or solid state drive (SSD), multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the unidirectional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes one or more processors 702 and one or more graphics processors 708, and may be a single processor desktop system, a multiprocessor workstation system, or a server system having a large number of processors 702 or processor cores 707. In one embodiment, the system 700 is a processing platform incorporated within a system-on-a-chip (SoC or SOC) integrated circuit for use in mobile, handheld, or embedded devices.

An embodiment of system 700 can include, or be incorporated within, a server-based gaming platform, a game console, including a game and media console, a mobile gaming console, a handheld game console, or an online game console. In some embodiments system 700 is a mobile phone, smart phone, tablet computing device or mobile Internet device. Data processing system 700 can also include, couple with, or be integrated within a wearable device, such as a smart watch wearable device, smart eyewear device, augmented reality device, or virtual reality device. In some embodiments, data processing system 700 is a television or set top box device having one or more processors 702 and a graphical interface generated by one or more graphics processors 708.

In some embodiments, the one or more processors 702 each include one or more processor cores 707 to process instructions which, when executed, perform operations for system and user software. In some embodiments, each of the one or more processor cores 707 is configured to process a specific instruction set 709. In some embodiments, instruction set 709 may facilitate Complex Instruction Set Computing (CISC), Reduced Instruction Set Computing (RISC), or computing via a Very Long Instruction Word (VLIW). Multiple processor cores 707 may each process a different instruction set 709, which may include instructions to facilitate the emulation of other instruction sets. Processor core 707 may also include other processing devices, such a Digital Signal Processor (DSP).

In some embodiments, the processor 702 includes cache memory 704. Depending on the architecture, the processor 702 can have a single internal cache or multiple levels of internal cache. In some embodiments, the cache memory 704 is shared among various components of the processor 702. In some embodiments, the processor 702 also uses an external cache (e.g., a Level-3 (L3) cache or Last Level Cache (LLC)) (not shown), which may be shared among processor cores 707 using known cache coherency techniques. A register file 706 is additionally included in processor 702 which may include different types of registers for storing different types of data (e.g., integer registers, floating point registers, status registers, and an instruction pointer register). Some registers may be general-purpose registers, while other registers may be specific to the design of the processor 702.

In some embodiments, one or more processor(s) 702 are coupled with one or more interface bus(es) 710 to transmit communication signals such as address, data, or control signals between processor 702 and other components in the system. The interface bus 710, in one embodiment, can be a processor bus, such as a version of the Direct Media Interface (DMI) bus. However, processor buses are not limited to the DMI bus, and may include one or more Peripheral Component Interconnect buses (e.g., PCI, PCI Express), memory buses, or other types of interface buses. In one embodiment the processor(s) 702 include an integrated memory controller 716 and a platform controller hub 730. The memory controller 716 facilitates communication between a memory device and other components of the system 700, while the platform controller hub (PCH) 730 provides connections to I/O devices via a local I/O bus.

Memory device 720 can be a dynamic random-access memory (DRAM) device, a static random-access memory (SRAM) device, non-volatile memory device such as flash memory device or phase-change memory device, or some other memory device having suitable performance to serve as process memory. Memory device 720 may further include non-volatile memory elements for storage of firmware. In one embodiment the memory device 720 can operate as system memory for the system 700, to store data 722 and instructions 721 for use when the one or more processors 702 execute an application or process. Memory controller hub 716 also couples with an optional external graphics processor 712, which may communicate with the one or more graphics processors 708 in processors 702 to perform graphics and media operations. In some embodiments a display device 711 can connect to the processor(s) 702. The display device 711 can be one or more of an internal display device, as in a mobile electronic device or a laptop device, or an external display device attached via a display interface (e.g., DisplayPort, etc.). In one embodiment the display device 711 can be a head mounted display (HMD) such as a stereoscopic display device for use in virtual reality (VR) applications or augmented reality (AR) applications.

In some embodiments the platform controller hub 730 enables peripherals to connect to memory device 720 and processor 702 via a high-speed I/O bus. The I/O peripherals include, but are not limited to, an audio controller 746, a network controller 734, a firmware interface 728, a wireless transceiver 726, touch sensors 725, a data storage device 724 (e.g., hard disk drive, flash memory, etc.). The data storage device 724 can connect via a storage interface (e.g., SATA) or via a peripheral bus, such as a Peripheral Component Interconnect bus (e.g., PCI, PCI Express). The touch sensors 725 can include touch screen sensors, pressure sensors, or fingerprint sensors. The wireless transceiver 726 can be a Wi-Fi transceiver, a Bluetooth transceiver, or a mobile network transceiver such as a 3G, 4G, Long Term Evolution (LTE), or 5G transceiver. The firmware interface 728 enables communication with system firmware, and can be, for example, a unified extensible firmware interface (UEFI). The network controller 734 can enable a network connection to a wired network. In some embodiments, a high-performance network controller (not shown) couples with the interface bus 710. The audio controller 746, in one embodiment, is a multi-channel high definition audio controller. In one embodiment the system 700 includes an optional legacy I/O controller 740 for coupling legacy (e.g., Personal System 2 (PS/2)) devices to the system. The platform controller hub 730 can also connect to one or more Universal Serial Bus (USB) controllers 742 connect input devices, such as keyboard and mouse 743 combinations, a camera 744, or other USB input devices.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

The following Examples pertain to certain embodiments:

In Example 1, a method includes capturing raw image data for a scene with a compressed sensing image sensor; performing reconstruction of the raw image data, including performing an enhancement reconstruction of the raw image data; and generating a masked image from the reconstruction of the raw image data, wherein the enhancement reconstruction includes applying enhancement utilizing a neural network trained with examples including image data in which private content is masked.

In Example 2, the scene includes private content, and the generated masked image masks the private content.

In Example 3, the private content is inaccessible in the reconstruction of the raw image data.

In Example 4, the private content includes faces of one or more individuals in the scene.

In Example 5, the reconstruction of the raw image data further includes performing an initial reconstruction of the raw image data prior to the enhancement reconstruction of the raw image data.

In Example 6, the neural network is trained to worsen private content in image data.

In Example 7, the method further includes performing an inference operation with the generated masked image.

In Example 8, an apparatus includes one or more processors and a compressed sensing image sensor to capture raw image data in imaging of a scene, wherein the one or more processors are to capture raw image data for a scene with the image sensor; perform reconstruction of the raw image data in a processing pipeline, including performing an enhancement reconstruction of the raw image data; and generate a masked image from the reconstruction of the raw image data, wherein the enhancement reconstruction includes applying enhancement utilizing a neural network trained with examples including image data in which private content is masked.

In Example 9, the scene includes private content, and the generated masked image masks the private content.

In Example 10, the private content is inaccessible in the reconstruction of the raw image data.

In Example 11, the reconstruction of the raw image data further includes the apparatus to perform an initial reconstruction of the raw image data prior to the enhancement reconstruction of the raw image data.

In Example 12, the neural network is trained to worsen private content in image data.

In Example 13, the one or more processors are further to perform an inference operation with the generated masked image.

In Example 14, the apparatus is a compressed sensing camera.

In Example 15, one or more non-transitory computer-readable storage mediums having stored thereon executable computer program instructions that, when executed by one or more processors, cause the one or more processors to perform operations including capturing raw image data for a scene with a compressed sensing image sensor; performing reconstruction of the raw image data, including performing an enhancement reconstruction of the raw image data; and generating a masked image from the reconstruction of the raw image data, wherein the enhancement reconstruction includes applying enhancement utilizing a neural network trained with examples including image data in which private content is masked.

In Example 16, the scene includes private content, and the generated masked image masks the private content.

In Example 17, the private content is inaccessible in the reconstruction of the raw image data.

In Example 18, the reconstruction of the raw image data further includes performing an initial reconstruction of the raw image data prior to the enhancement reconstruction of the raw image data.

In Example 19, the instructions further include instructions for training the neural network to worsen private content in image data.

In Example 20, the instructions further include instructions for performing an inference operation with the generated masked image.

In Example 21, an apparatus includes means for capturing raw image data for a scene with a compressed sensing image sensor; means for performing reconstruction of the raw image data, including performing an enhancement reconstruction of the raw image data; and means for generating a masked image from the reconstruction of the raw image data, wherein the enhancement reconstruction includes applying enhancement utilizing a neural network trained with examples including image data in which private content is masked.

In Example 22, the scene includes private content, and the generated masked image masks the private content.

In Example 23, the private content is inaccessible in the reconstruction of the raw image data.

In Example 24, the means for performing reconstruction of the raw image data further includes means for performing an initial reconstruction of the raw image data prior to the enhancement reconstruction of the raw image data.

In Example 25, the apparatus further includes means for training the neural network to worsen private content in image data.

In Example 26, the apparatus further includes means for performing an inference operation with the generated masked image.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. A method comprising:
capturing raw image data for a scene with a compressed sensing image sensor;
performing reconstruction of the raw image data, including performing an enhancement reconstruction of the raw image data; and
generating a masked image from the reconstruction of the raw image data;
wherein the enhancement reconstruction includes applying enhancement utilizing a neural network trained with examples including image data in which private content is masked.

2. The method of claim 1, wherein the scene includes private content, and the generated masked image masks the private content.

3. The method of claim 2, wherein the private content is inaccessible in the reconstruction of the raw image data.

4. The method of claim 2, wherein the private content includes faces of one or more individuals in the scene.

5. The method of claim 1, wherein the reconstruction of the raw image data further includes performing an initial reconstruction of the raw image data prior to the enhancement reconstruction of the raw image data.

6. The method of claim 1, wherein the neural network is trained to worsen private content in image data.

7. The method of claim 1, wherein the method further includes performing an inference operation with the generated masked image.

8. An apparatus comprising:
one or more processors; and
a compressed sensing image sensor to capture raw image data in imaging of a scene;
wherein the one or more processors are to:
capture raw image data for a scene with the image sensor;
perform reconstruction of the raw image data in a processing pipeline, including performing an enhancement reconstruction of the raw image data; and
generate a masked image from the reconstruction of the raw image data;
wherein the enhancement reconstruction includes applying enhancement utilizing a neural network trained with examples including image data in which private content is masked.

9. The apparatus of claim 8, wherein the scene includes private content, and the generated masked image masks the private content.

10. The apparatus of claim 9, wherein the private content is inaccessible in the reconstruction of the raw image data.

11. The apparatus of claim 8, wherein the reconstruction of the raw image data further includes the apparatus to perform an initial reconstruction of the raw image data prior to the enhancement reconstruction of the raw image data.

12. The apparatus of claim 8, wherein the neural network is trained to worsen private content in image data.

13. The apparatus of claim 8, wherein the one or more processors are further to:
perform an inference operation with the generated masked image.

14. The apparatus of claim 8, wherein the apparatus is a compressed sensing camera.

15. One or more non-transitory computer-readable storage mediums having stored thereon executable computer program instructions that, when executed by one or more processors, cause the one or more processors to perform operations comprising:
capturing raw image data for a scene with a compressed sensing image sensor;
performing reconstruction of the raw image data, including performing an enhancement reconstruction of the raw image data; and
generating a masked image from the reconstruction of the raw image data;
wherein the enhancement reconstruction includes applying enhancement utilizing a neural network trained with examples including image data in which private content is masked.

16. The storage mediums of claim 15, wherein the scene includes private content, and the generated masked image masks the private content.

17. The storage mediums of claim 16, wherein the private content is inaccessible in the reconstruction of the raw image data.

18. The storage mediums of claim 15, wherein the reconstruction of the raw image data further includes performing an initial reconstruction of the raw image data prior to the enhancement reconstruction of the raw image data.

19. The storage mediums of claim 15, wherein the instructions further include instructions for:
training the neural network to worsen private content in image data.

20. The storage mediums of claim 15, wherein the instructions further include instructions for:
performing an inference operation with the generated masked image.
